(19) United States
(12) Patent Application Publication
(10) Pub. No.: US 2026/0028171 A1
(43) Pub. Date: Jan. 29, 2026

(54) COFFEE SLEEVE WITH GREETING CARD

(71) Applicant: Tonia D. Silva, Elverta, CA (US)

(72) Inventor: Tonia D. Silva, Elverta, CA (US)

(21) Appl. No.: 18/635,002

(22) Filed: Apr. 15, 2024

(51) Int. Cl. B65D 81/38; B42D 15/02

(52) U.S. Cl. CPC B65D 81/3876; B42D 15/027

(57) ABSTRACT

According to an aspect of the present invention disclosed herein, there is provided a sleeve for a beverage, comprising: a paperboard material circumferentially surrounding a beverage container; a first perforation; and a second perforation, wherein: the circumferential extent of the paperboard material is greater than the circumferential extent of the beverage container so that the paperboard material is configured to overlap on itself wrapped around the beverage container to form an overlapping section; the paperboard material is glued at the overlapping section; and the first perforation and the second perforation are on either side of the overlapping section. A greeting card message is printed on the inside and outside of the paperboard material and can be removed by tearing at the perforations.

### BACKGROUND

The present invention is in the technical field of beverage sleeves. More particularly the invention is in the field of beverage sleeves which provide for safe handling of hot beverages like coffee.

For many decades people have been frequenting coffee shops, gas stations, take-out restaurants and the like to obtain beverages to take “on the go.” With the rise of coffee shops, the coffee-culture has become more popular and have become more than just sit down restaurants, they are “take-out” coffee shops dispensing hot beverages for people everywhere. During the rise of the coffee culture, many inventions as well as accommodations have been made to try and eliminate the inconveniences caused by hot beverages which include heat discomfort.

A number of beverage sleeves for hot beverages have been described in the prior art patent literature. For example, U.S. Pat. No. 10,327,574 describes a cup sleeve formed with a reverse damping structure having one or more rings inwardly bent and annularly arranged on one or both of the edge and the inner periphery of the cup sleeve, so when the mentioned cup sleeve is sleeved with a cup-shaped or bottle-shaped or can-shaped container, the anti-slip damping for enhancing the anti-loose function is provided by the reverse damping structure, thus the cup sleeve is less likely to be released from the cup-shaped or bottle-shaped or can-shaped container, and with the reverse damping structure, the interval formed between the cup sleeve and the cup-shaped or bottle-shaped or can-shaped container is enlarged thereby increasing the thermal insulation effect.

While coffee sleeves have been helpful in easing handling of hot beverages, however, used coffee sleeves are typically discarded and it would be desirable if there were another use for them.

### SUMMARY OF INVENTION

Therefore, the present invention is a coffee sleeve which doubles as a greeting card. There are perforations on the coffee sleeve, so that a user can easily tear off part of the coffee sleeve containing a greeting card message. A greeting card message can be printed on the inside and outside. The greeting card can then be viewed by the user and saved.

According to an aspect of the present invention disclosed herein, there is provided a sleeve for a beverage, comprising: a paperboard material circumferentially surrounding a beverage container; a first perforation; and a second perforation, wherein: the circumferential extent of the paperboard material is greater than the circumferential extent of the beverage container so that the paperboard material is configured to overlap on itself wrapped around the beverage container to form an overlapping section; the paperboard material is glued at the overlapping section; and the first perforation and the second perforation are on either side of the overlapping section. A greeting card message is printed on the inside and outside of the paperboard material and can be removed by tearing at the perforations.

### BRIEF DESCRIPTION OF THE DRAWINGS

FIG. 1 is an illustration of the coffee sleeve of the present invention attached to a cup of coffee.

FIG. 2 is an illustration of the greeting card contained within the coffee sleeve of the present invention.

### DETAILED DESCRIPTION

Embodiments of the present invention will be described with reference to the following drawings.

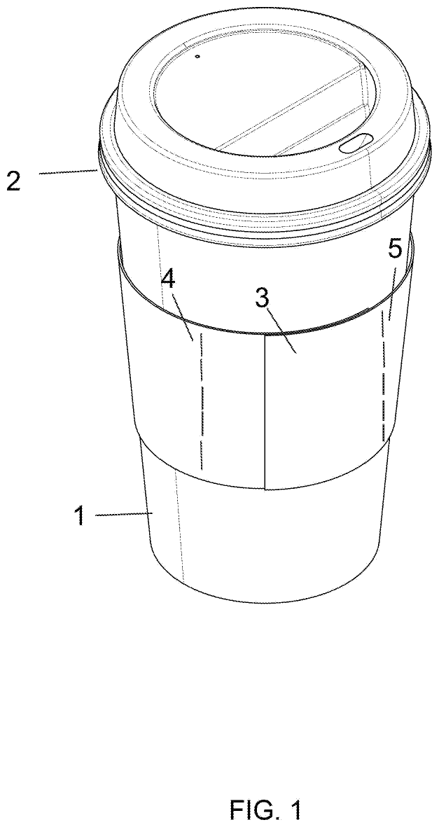

FIG. 1 is an illustration of the coffee sleeve of the present invention attached to a cup of coffee.

As can be seen in FIG. 1, there are two perforations. A standard coffee jacket is glued and crosses over each other. The present invention has perforations on either side of that glue.

First perforation 4 is on the left side of the point where the jacket is glued and crosses over. Second perforation 5 is on the right side of the point where the jacket is glued and crosses over. By separating at the first perforation and the second perforation the glue and material attached to the glue 3 can remain on the coffee cup, which enhances the convenience and ease of use of the present invention.

Coffee cup 1 can also be provided with lid 2, customarily, although it is possible coffee cup 1 could be provided without a lid as well without affecting the function of the present invention.

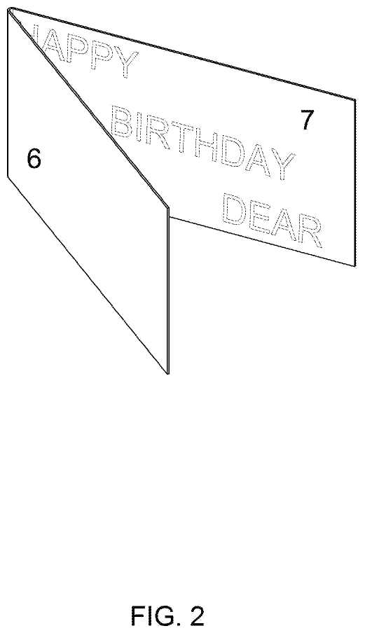

FIG. 2 is an illustration of the greeting card contained within the coffee sleeve of the present invention.

The greeting card 6 is the portion of the coffee sleeve illustrated in FIG. 1 circumferentially between the first perforation 4 and the second perforation 5, i.e., on the cup to the left of first perforation 4 and to the right of second perforation 5.

The material used for the coffee sleeve of the present invention will typically made of textured paperboard, but can be found made of other materials.

Greeting card message 7 can be a variety of messages appropriate for the occasion, such as a birthday, anniversary or other personally significant day, or can be a broadly applicable holiday message such as Happy Thanksgiving or Merry Christmas, and is printed on the inside surface of greeting card 6 or the outside surface of greeting card 6 or both surfaces simultaneously.

The illustrations of embodiments described herein are intended to provide a general understanding of the structure of various embodiments, and they are not intended to serve as a complete description of all the elements and features of apparatus and systems that might make use of the structures described herein. Other embodiments may be utilized and derived therefrom, such that structural and logical substitutions and changes may be made without departing from the scope of this disclosure.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

Figures are also merely representational and may not be drawn to scale. Certain proportions thereof may be exaggerated, while others may be minimized. Accordingly, the specification and drawings are to be regarded in an illustrative rather than a restrictive sense.

What is claimed is:

1. A sleeve for a beverage, comprising:
a paperboard material circumferentially surrounding a beverage container;
a first perforation; and
a second perforation,
wherein:
the circumferential extent of the paperboard material is greater than the circumferential extent of the beverage container so that the paperboard material is configured to overlap on itself wrapped around the beverage container to form an overlapping section;
the paperboard material is glued at the overlapping section; and
the first perforation and the second perforation are on either side of the overlapping section.

2. The sleeve for a beverage of claim 1, further comprising a greeting card message printed on the paperboard material.

3. The sleeve for a beverage of claim 2, wherein the greeting card message is printed on the inside surface of the paperboard material.

4. The sleeve for a beverage of claim 2, wherein the greeting card message is printed on the outside surface of the paperboard material.
